(19) United States
(12) Patent Application Publication
(10) Pub. No.: US 2025/0112721 A1
(43) Pub. Date: Apr. 3, 2025

(54) SYSTEM FOR ADAPTIVE ROUTING IN TIME DIVISION MULTIPLE ACCESS-BASED WIDEBAND MOBILE ADHOC NETWORK

(71) Applicant: VIETTEL GROUP, Ha Noi City (VN)

(72) Inventors: TRUONG XUAN DO, Ha Noi City (VN); THAI BINH NGUYEN, Ha Noi City (VN); HUU TUNG DANG, Ha Noi City (VN); DANG HIEU LE, Ha Noi City (VN); MANH LINH NGUYEN, Ha Noi City (VN); HONG HUY THONG NGUYEN, Ha Noi City (VN); MINH TUNG DUONG, Ha Noi City (VN); THANH BINH NGO, Ha Noi City (VN); THI HOAI LINH NGUYEN, Ha Noi City (VN)

(73) Assignee: VIETTEL GROUP, Ha Noi City (VN)

(21) Appl. No.: 18/899,778

(22) Filed: Sep. 27, 2024

(30) Foreign Application Priority Data
Oct. 3, 2023 (VN) 1-2023-06879

(51) Int. Cl. H04J 3/24; H04W 72/0446

(52) U.S. Cl. CPC H04J 3/24; H04W 72/0446

(57) ABSTRACT

System for adaptive routing in time division multiple access-based wideband mobile adhoc network employs an enhanced OLSR-based routing protocol designed for TDMA-based mobile adhoc network to spread the link quality information and calculates adaptive routing paths based on the link quality. The system employs a signal-to-noise ratio calculation, demodulation and decoding block, link quality estimator, FIFO, link quality broadcast, network layer link state broadcast, link state table, adaptive routing, path calculation block and routing table blocks to achieve the desired results.

### TECHNICAL FIELD OF THE INVENTION

The invention presents the system for adaptive routing in mobile wideband adhoc networks. The system discussed is applied in the military communication field.

### BACKGROUND OF THE INVENTION

The time division multiple access-based wideband mobile adhoc network (TDMA-based WMANET) consists of moving network nodes, which are connected to other nodes in the communication range to transmit and receive the high speed data. The network node performs time division multiple access (TDMA) protocol to select time slots to broadcast data to neighbor nodes in its range. In order to transmit data to the destination nodes outside of its range, the network nodes are required to perform routing protocols to generate the routing tables, which allow relaying of the data packets through intermediary nodes to destination nodes.

Routing protocols in WMANET are classified into two major categories: On-demand routing protocols (e.g., adhoc on-demand distance vector protocol-AODV) and active routing protocols (e.g., Optimized Link State Routing-OLSR). In on-demand routing protocols, the network nodes broadcast path request packets to find the routes to destination nodes when nodes demand to transfer data. The on-demand routing has large latency because the routing path is established on data transfer request. In active routing protocols, control packets at the network layer containing link state between nodes and their neighbors are periodically broadcasted and relayed among nodes in the network topology. After receiving these control packets, the intermediary nodes update the link state between nodes and calculate routing tables for whole network topology. This approach makes routing tables always available to use when a node demands to transfer data. However, current active protocols are based on the shortest path routing, which is the shortest in terms of the network hop number. In the WMANET, due to obstables and changeable communication range between nodes, the link quality can be varied. This results in the fact that, the shortest path is not always the most optimal path for data transfer.

In order to solve these issues, the invention presents an adaptive routing protocol based on the link quality, which can be used in the TDMA-based WMANET. The invention comprises a system and methods to estimate and evaluate the link quality between network nodes using control messages broadcasted periodically between nodes in the time-division multiple access (TDMA) network. The invention also presents an enhanced OLSR-based routing protocol designed for TDMA-based mobile adhoc network which allows to spread the link quality information over the network topology and adaptively calculate the routing path based on the link quality.

### BRIEF SUMMARY OF THE INVENTION

The purpose of invention is to propose a system, which allows to estimate and evaluate the link quality between network nodes in the TDMA-based WMANET. The link quality evaluation methods are based on the exchange of control messages in the TDMA protocol. The system is designed for thirty-two network nodes.

The invention also proposes an enhanced OLSR-based routing protocol designed for TDMA-based mobile adhoc network to spread the link quality information and proposes an algorithm to calculate adaptive routing paths based on the link quality.

In order to achieve the above purpose, the system mentioned in the invention consists of following blocks:

Signal-to-noise ratio calculation block 100:this block will perform calculation and estimation of link quality based on IQ samples collected from control messages at MAC layer.

Demodulation and decoding block 101: this bock will perform the demodulation and decode from IQ samples to information bit and send to medium access layer.

Link quality estimator block 102: this block will filter, calculate and estimate the link quality between one node and its neighbor nodes via control messages received from neighbor nodes.

FIFO (first in first out) buffer block 103: this block consists of FIFO to store SNR values collected from neighbor nodes in 24 TDMA periods.

Link quality broadcast block 104: this block will generate and broadcast control messages containing link quality to neighbor nodes.

Network layer link state broadcast block 105: this block will periodically generate link state broadcast messages containing link quality information of neighbor nodes to whole network.

Link state table 106: this block consists of link state and link quality information of whole network topology.

Adaptive routing block 107: this block will update the link state and link quality of whole network topology. This block also triggers the path calculation block 108 to calculate the best routing path and updates routing table.

Path calculation block 108: this block will use link state information of whole network topology to calculate the best routing paths to network nodes.

Routing table block 109: this block stores information of next network nodes to forward packets to the destination nodes.

### BRIEF DESCRIPTION OF THE DRAWINGS

FIG. 1: illustrates the functional blocks of a network node;

FIG. 2: illustrates the mapping of link quality;

FIG. 3: illustrates the format of control message at the medium access layer; and

FIG. 4: illustrates the format of link state broadcast message at network layer.

### DETAILED DESCRIPTION OF THE INVENTION

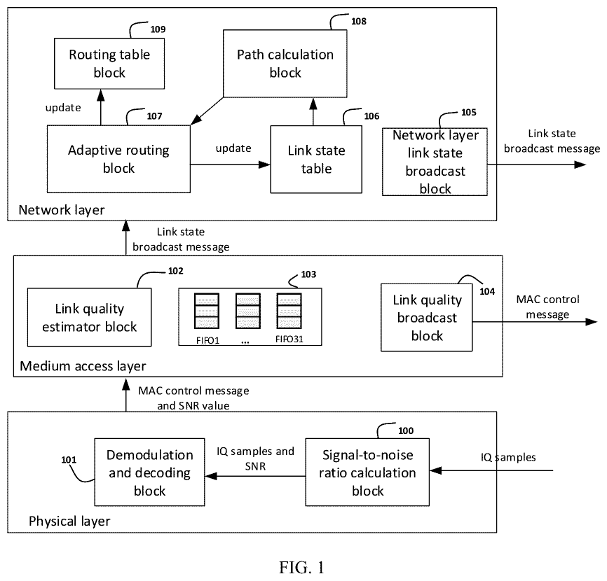

FIG. 1 illustrates the functional blocks of a network node, which features a adaptive routing. The functional blocks include:

Signal-to-noise ratio calculation block 100:this block will perform calculation and estimation of link quality based on IQ samples collected from control messages at MAC layer.

Demodulation and decoding block 101: this bock will perform the demodulation and decode from IQ samples to information bit and send to medium access layer.

Link quality estimator block 102: this block will filter, calculate and estimate the link quality between one node and its neighbor nodes via control messages received from neighbor nodes.

FIFO (first in first out) buffer block 103: this block consists of FIFO to store SNR values collected from neighbor nodes in 24 TDMA periods.

Link quality broadcast block 104: this block will generate and broadcast control messages containing link quality to neighbor nodes.

Network layer link state broadcast block 105: this block will periodically generate link state broadcast messages containing link quality information of neighbor nodes to whole network.

Link state table 106: this block consists of link state and link quality information of whole network topology.

Adaptive routing block 107: this block will update the link state and link quality of whole network topology. This block also triggers the path calculation block 108 to calculate the best routing path and updates routing table.

Path calculation block 108: this block will use link state information of whole network topology to calculate the best routing paths to network nodes.

Routing table block 109: this block stores information of next network nodes to forward packets to the destination nodes.

Signal-to-noise ratio calculation block 100:this block estimates the signal-to-noise ratio (SNR) from received IQ (In-Phase and Quadarature) samples collected from the transceiver of system. After having calculated the SNR from IQ samples. The IQ samples are fed into the block 101 to perform demodulation and decoding. Then, the control packet at bit format and its estimated SNR will be forwarded to the medium access layer. The method used to calculate SNR value consists of following steps:

Step 1: calculate SNR for each subcarrier based on known pilot samples.
Assume that our system uses the OFDM modulation scheme with N QPSK samples C (k,n) with k is the index of OFDM symbol and n is the index of subcarrier. H (n) denotes the channel estimation. R (k,n) denotes the received pilot sample. The SNR value is estimated using following equation.

$${SNR}_{n} = ( \frac{1}{N} * {\sum }_{n}^{N} {\vert H ( k , n ) \vert}^{2} ) / ( \frac{1}{2} * {\sum }_{k}^{2} {\vert R ( k , n ) - H ( n ) * C ( k , n ) \vert}^{2} )$$

Then SNR is calculated for all subcarriers:

$$SNR = {\sum }_{n}^{N} {SNR}_{n} / N$$

Step 2: The SNR values are calculated at the step 1 are filtered using a Kalman filter. This step filters noise for estimated SNR values. SNR(m, m−1), P (m, m−1) are estimated SNR and covariance at the time m−1 for the time m. R (m) denotes the variance of SNR measurement. Q(m) denotes the variance of process noise.

Z(m) denotes SNR measurement at time m.
state update equation:

$$SNR ( m , m ) = SNR ( m , m - 1 ) + K ( m ) * ( Z ( m ) - SNR ( m , m - 1 ) )$$

Covariance update equation:

$$P ( m , m ) = ( 1 - K ( m ) ) * P ( m , m - 1 )$$

Kalman gain calculation:

$$K ( m ) = P ( m , m - 1 ) / ( P ( m , m - 1 ) + R ( m ) )$$

SNR extrapolation equation:

$$SNR ( m + 1 , m ) = SNR ( m , m )$$

Covariance exatrapolation equation:

$$P ( m + 1 , m ) = P ( m , m ) + Q ( m )$$

Demodulation and decoding block 101: this block demodulates and decode IQ samples into information bits and sends to medium access layer. This block is not presented.

Link quality estimator block 102: this block collects, filters, calculates the link quality based on the SNR values collected from neighbor network nodes. At the same time, this block also decodes the control messages received from block 101 to obtain the link quality measured at the neighbor side. This block depends on the number of neighbor nodes and creates the corresponding number of FIFOs. Each FIFO stores the SNR values calculated from IQ samples of control messages transmitted from neighbor nodes. After each twenty-four TDMA periods, this block will estimate the link quality using following steps:

Step 1: filter out outlier SNR values.
Calculate mean and standard deviation of SNR values in each FIFO:

$${μ}_{S N R} = {\sum }_{i}^{N} S N {R}_{i} / N$$

$${σ}_{S N R} = \sqrt{\frac{{\sum }_{i}^{N} {( S N {R}_{i} - {μ}_{S N R} )}^{2}}{N}}$$

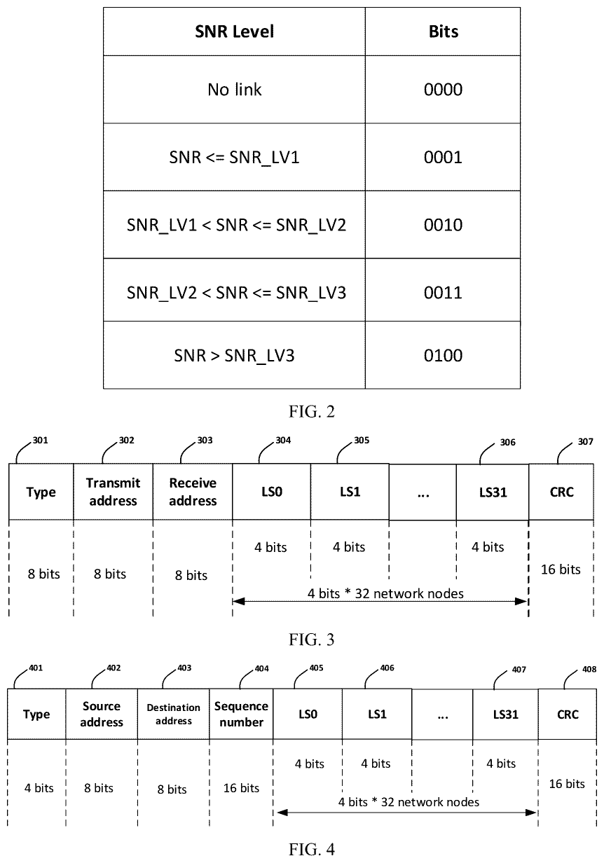

SNR values outside [USNR-2*OSNR, HISNR+2*OSNR] will be removed
   Step 2: recalculate the mean of SNR values after removing all outlier data.
   Step 3: convert SNR value into decibel and map the SNR value into one of four levels of link quality. The SNR levels can be determined based on experiment. FIG. 2 illustrates the mapping of SNR values into specific levels of link quality. The higher the level, the better the link quality.
SNR<=SNR_LV1 (db), the level of link quality is 1;
SNR_LV1<SNR<=SNR_LV2 (db), the level of link quality is 2;
SNR_LV2<SNR<=SNR_LV3 (db), the level of link quality is 3;
SNR>SNR_LV3 (db), the level of link quality is 4.

When decoding the control messages from neighbor nodes, the link quality levels measured at the neighbor side are also collected. Based the calculated and received link quality levels, the estimator block will decide the link quality using the smaller level.

FIFO buffer block 103: this block is responsible for storing the SNR values calculated from IQ samples of control messages. Each FIFO buffer will be created for each neighbor node.

Link quality broadcast block 104: this block is responsible for broadcasting the link quality levels measured for neighbor nodes using control messages every eight TDMA periods. FIG. 3 illustrates the format of control message at the medium access layer. The value of link quality level is encoded using four bits and obtained from link quality estimator block 102.

The format of control message consists of following fields:
Field 301: type of control message
Field 302: ID of transmitting node
Field 303: ID of receiving node
Field LS0 304: level of link quality with neighbor node having ID 0
Field LS1 305: level of link quality with neighbor node having ID 1
Field LS31 306: level of link quality with neighbor node having ID 31
Field 307: CRC code

Network layer link state broadcast block 105: this block is responsible for making to link state broadcast messages, which is used to broadcast the link state between the network node and its neighbors over whole network topology. FIG. 4 illustrates the format of link state broadcast message at the network layer. The format of link state broadcast message has the following fields:
Field 401: type of link state broadcast message
Field 402: ID of source node
Field 403: ID of destination node
Field 404: the sequence number of link state broadcast message
Field 405: level of link quality with neighbor node having ID 0
Field 406: level of link quality with neighbor node having ID 1
Field 407: level of link quality with neighbor node having ID 31
Field 408: CRC code.

Network layer link state broadcast block 105: this block periodically generates and sends the link state broadcast message. The field 402 of the message is the ID of node, which generates this link state broadcast message. The field 403 of message is the broadcast value. Field 403 increases one each time a new link state broadast message is generated. The other fields encode the level of link quality of neighbor nodes, which can be obtained from the block 102. The network nodes, which are not neighbor nodes, have the level of link quality equal zero.

Link state table block 106: this block consists the information of links in the whole network topology. This table is updated each time the network node receives a link state broadcast message. This table is an input of the path calculation 108. The link state table consists of records with following fields:
Source ID: this field is the ID of source node, which generates the link state broadcast message
Neighbor ID: this field is the ID of neighbor node of source node;
Sequence number: this field is generated by the block 105 each time a new link state broadcast message is generated;
Link quality level: this field has the value from zero to four.

Adaptive routing block 107: this block is responsible for processing the link state broadcast messages received from medium access layer. After receiving a link state broadcast message, this block updates the link state table 106. The update process consists of following steps:
Step 1: remove all records in the link state table 106 with the source ID field same as the source address field of link state broadcast message and with sequence number smaller than the sequence number field in link state broadcast message;
Step 2: add into link state table with records having following fields:
   Source ID: the source address field of link state broadcast message;
   Neighbor ID: the ID of neighbor node with link quality level greater than zero;
   Sequence number: the sequence number field of link state broadcast message;
   Link quality level: the link quality level of corresponding neighbor ID;

Each time the link state table is updated, the adaptive routing block 107 will call the path calculation block 108 to calculate the optimal paths to network nodes in the topology.

Path calculation 108: this block will calculate reliable routing paths based on the information of link state and link quality level in the link state table 106. The path calculation algorithm consists of following steps:
Step 1: generate a cost matrix with the cost is defined as a reverse of link quality level:

$$Cost [ i ] [ j ] = \frac{1}{Link quality level between i and j}$$

Network nodes i j, which do not have link Cost [i] [j]=INFINITY
Step 2: to calculate the routing paths from nodeID to other nodes in the network topology with the most reliable paths. Initiate following arrays: TotalCost [i] stores the toal cost to node i from node nodeID, prev [i] store the ID of node to node i, checked [i] has value of 1 if node i has been checked. Initial values are set as followings:
   TotalCost [i]=Cost [nodeID] [i]
      prev [i]=nodeID
         checked [i]=0
Step 3: select a network node with checked [i]=0 and have the least TotalCost [i]. Store i and TotalCost [i] into two variables NextNode, MinCost. Set the variable checked [NextNode]=1.
Step 4: go through each node with checked [i]=0. If node i satisfies:

$$MinCost + Cost [ NextNode ] [ i ] < TotalCost [ i ]$$

The TotalCost [i] and prev [i] will be updated using following equations:

$$TotalCost [ i ] = MinCost + Cost [ NextNode ] [ i ]$$

$$prev [ i ] = NextNode$$

Step 5: repeat step 3 and 4 for 31 times to obtain routing paths to node i from source node nodeID.

Routing table block 109: this block is used to forward packets from source to destination. This routing table block is updated using the path calculation information from the block 108. This block consists of records with following fields:
Destination node: the value of i;
Previous node: the value of prev [i];
Total cost: TotalCost [i];
The next hop: the next hop to forward packet when a packet arrives in node i

The next hop information to forward the packet can be found by querying recursively from the destination node to previous node. Until the ID of previous node matches with the ID of source node of packet, the next hop is the destination node with the previous node, which is the source node.

1. A system for adaptive routing in time division multiple access-based wideband mobile adhoc network:
A signal-to-noise ratio calculation block:this block estimates a signal-to-noise ratio (SNR) from received IQ (In-Phase and Quadarature) samples collected from a transceiver of system, after having calculated the SNR from IQ samples, the IQ samples are fed into a perform demodulation and decoding block, then, a control packet at bit format and its estimated SNR will be forwarded to a medium access layer, the method used to calculate SNR value consists of following steps:
Step 1: calculate SNR for each subcarrier based on known pilot samples;
Step 2: the SNR values are calculated at the step 1 are filtered using a Kalman filter, to filter noise for estimated SNR values;
a link quality estimator block: this block collects, filters, calculates the link quality based on the SNR values collected from neighbor network nodes; At the same time, this block also decodes the control messages to obtain the link quality measured at the neighbor side, this block depends on the number of neighbor nodes and creates the corresponding number of FIFOs, each FIFO stores the SNR values calculated from IQ samples of control messages transmitted from neighbor nodes, after each twenty-four TDMA periods, this block will estimate the link quality using following steps:
Step 1: filter out outlier SNR value;
Step 2: recalculate the mean of SNR values after removing outlier data;
Step 3: convert SNR value into decibel and map the SNR value into one of four levels of link quality;
a link quality broadcast block: this block is responsible for broadcasting the link quality levels measured for neighbor nodes using control messages every eight TDMA periods, the value of link quality level is encoded using four bits and obtained from link quality estimator block;
a network layer link state broadcast block: this block is responsible for making to link state broadcast messages, which is used to broadcast the link state between the network node and its neighbors over whole network topology; a link state table block: this block consists the information of links in the whole network topology, this table is updated each time the network node receives a link state broadcast message;
an adaptive routing block: this block is responsible for processing the link state broadcast messages received from medium access layer, after receiving a link state broadcast message, this block updates the link state table, wherein the update process consists of following steps:
Step 1: remove all records in the link state table block with the source ID field same as the source address field of link state broadcast message and with sequence number smaller than the sequence number field in link state broadcast message;
Step 2: add into link state table with records having following fields:
Source ID: the source address field of link state broadcast message;
Neighbor ID: the ID of neighbor node with link quality level greater than zero;
Sequence number: the sequence number field of link state broadcast message;
Link quality level: the link quality level of corresponding neighbor ID;
Path calculation block: this blockcalculates reliable routing paths based on the information of link state and link quality level in the link state table.

2. A system for adaptive routing in time division multiple access-based wideband mobile adhoc network according to claim 1, wherein:
in a signal-to-noise ratio calculation block:the method used to calculate SNR value consists of following steps:
Step 1: calculate SNR for each subcarrier based on known pilot samples;
assume that the system uses the OFDM modulation scheme with N QPSK samples C (k,n) with k is the index of OFDM symbol and n is the index of subcarrier, H (n) denotes the channel estimation, R (k,n) denotes the received pilot sample, the SNR value is estimated using following equation:
$$S N {R}_{n} = ( \frac{1}{N} * {\sum }_{n}^{N} {\vert H ( k , n ) \vert}^{2} ) / ( \frac{1}{2} * {\sum }_{k}^{2} {\vert R ( k , n ) - H ( n ) * C ( k , n ) \vert}^{2} )$$
Then SNR is calculated for all subcarriers:
$$S N R = {\sum }_{n}^{N} S N {R}_{n} / N$$
Step 2: The SNR values are calculated at the step 1 are filtered using a Kalman filter, this step filters noise for estimated SNR values, SNR(m, m−1), P (m, m−1) are estimated SNR and covariance at the time m−1 for the time m, R (m) denotes the variance of SNR measurement, Q(m) denotes the variance of process noise, Z(m) denotes SNR measurement at time m;
SNR state update equation:
$$S N R ( m , m ) = S N R ( m , m - 1 ) + K ( m ) * ( Z ( m ) - S N R ( m , m - 1 ) )$$
Covariance update equation:
$$P ( m , m ) = ( 1 - K ( m ) ) * P ( m , m - 1 )$$
Kalman gain calculation:
$$K ( m ) = P ( m , m - 1 ) / ( P ( m , m - 1 ) + R ( m ) )$$
SNR extrapolation equation:
$$S N R ( m + 1 , m ) = S N R ( m , m )$$
Covariance exatrapolation equation:
$$P ( m + 1 , m ) = P ( m , m ) + Q ( m ) .$$

3. A system for adaptive routing in time division multiple access-based wideband mobile adhoc network according to claim 1, wherein:
in a link quality estimator block: the method used to estmate link quality consists of following steps:
Step 1: filter out outlier SNR values;
Calculate mean and standard deviation of SNR values in each FIFO:
$${μ}_{S N R} = {\sum }_{i}^{N} S N {R}_{i} / N$$
$${σ}_{S N R} = \sqrt{\frac{{\sum }_{i}^{N} {( S N {R}_{i} - {μ}_{S N R} )}^{2}}{N}}$$
SNR values outside [USNR-2*OSNR, ULSNR+2*OSNR] will be removed
Step 2: recalculate the mean of SNR values after removing all outlier data;
Step 3: convert SNR value into decibel and map the SNR value into one of four levels of link quality, the SNR levels can be determined based on experiment, the higher the level, the better the link quality;
SNR<=SNR_LV1 (db), the level of link quality is 1;
SNR_LV1<SNR<=SNR_LV2 (db), the level of link quality is 2;
SNR_LV2<SNR<=SNR_LV3 (db), the level of link quality is 3;
SNR>SNR_LV3 (db), the level of link quality is 4.

4. A system for adaptive routing in time division multiple access-based wideband mobile adhoc network according to claim 1, wherein:
in a path calculation block: the method used to calculate routing paths based on link quality consists of following steps:
Step 1: generate a cost matrix with the cost is defined as a reverse of link quality level:
$$Cost [ i ] [ j ] = \frac{1}{Link quality level between i and j}$$
Network nodes i j, which do not have link Cost [i] [j]=INFINITY Step 2: to calculate the routing paths from nodeID to other nodes in the network topology with the most reliable paths, initiate following arrays: TotalCost [i] stores the toal cost to node i from node nodeID, prev [i] store the ID of node to node i, checked [i] has value of 1 if node i has been checked, initial values are set as followings:
TotalCost [i]=Cost [nodeID] [i]
prev [i]=nodeID
checked [i]=0
Step 3: select a network node with checked [i]=0 and have the least TotalCost [i], store i and TotalCost [i] into two variables NextNode, MinCost, set the variable checked [NextNode]=1;
Step 4: go through each node with checked [i]=0, if node i satisfies:
$$MinCost + Cost [ NextNode ] [ i ] < TotalCost [ i ]$$
The TotalCost [i] and prev [i] will be updated using following equations:
$$TotalCost [ i ] = MinCost + Cost [ NextNode ] [ i ]$$
$$prev [ i ] = NextNode$$
Step 5: repeat step 3 and 4 for 31 times to obtain routing paths to node i from source node nodeID.
